(19) United States
(12) Patent Application Publication
(10) Pub. No.: US 2024/0152152 A1
(43) Pub. Date: May 9, 2024

(54) Collaborative Capability Enhancement Among Machines

(71) Applicant: International Business Machines Corporation, Armonk, NY (US)

(72) Inventors: Edinar Lopes de Aquino, JR., Sao Paulo (BR); Adriana Pellegrini Furnielis, Sao Paulo (BR); Abhishek Jain, Baraut (IN); Sarbajit K. Rakshit, Kolkata (IN)

(21) Appl. No.: 18/052,247

(22) Filed: Nov. 3, 2022

(51) Int. Cl. G05D 1/02; G05B 13/02

(52) U.S. Cl. CPC G05D 1/0287; G05B 13/0265; G05D 1/0276; G05D 2201/0216

(57) ABSTRACT

Collaborative machine capability enhancement is provided. It is determined whether an automated mobile machine is capable of performing an activity based on analysis of information corresponding to the activity and capabilities of the automated mobile machine. In response to determining that the automated mobile machine is incapable of performing the activity based on the analysis of the information corresponding to the activity and the capabilities of the automated mobile machine, a digital twin simulation associated with performing the activity is performed using the information corresponding to the activity and the capabilities of the automated mobile machine. An analysis of a result of the digital twin simulation associated with performing the activity is performed. A number of additional automated mobile machines needed to collaboratively perform the activity is determined based on the analysis of the result of the digital twin simulation.

### BACKGROUND

### 1. Field

The disclosure relates generally to automated mobile machines and more specifically to enhancing automated mobile machine capabilities by enabling machine capability collaboration among a group of automated mobile machines to perform assigned activities in a warehouse environment.

### 2. Description of the Related Art

Automated mobile machines operate without the need for human control or intervention enabling increased productivity and efficiency, while lowering overall costs. Automated mobile machines are flexible and reliable where repetitive movement is needed. Automated mobile machines are available in different configurations for carrying payloads and performing other activities with greater safety. Automated mobile machines are capable of understanding and moving through their environment without human supervision. Typically, this capability is achieved using an array of on-board sensors, computers, floorplans, and the like. In a warehouse environment, these automated mobile machines create their own navigation paths or routes between locations to transport objects (e.g., products, packages, freight, material, and the like) within the warehouse facility, identify and avoid obstacles (e.g., warehouse infrastructure, workers, and the like), and reroute themselves when necessary.

### SUMMARY

According to one illustrative embodiment, a computer-implemented method for collaborative machine capability enhancement is provided. An automated mobile machine determines whether the automated mobile machine is capable of performing an activity based on analysis of information corresponding to the activity and capabilities of the automated mobile machine. In response to the automated mobile machine determining that the automated mobile machine is incapable of performing the activity based on the analysis of the information corresponding to the activity and the capabilities of the automated mobile machine, the automated mobile machine performs a digital twin simulation associated with performing the activity using the information corresponding to the activity and the capabilities of the automated mobile machine. The automated mobile machine performs an analysis of a result of the digital twin simulation associated with performing the activity. The automated mobile machine determines a number of additional automated mobile machines needed to collaboratively perform the activity based on the analysis of the result of the digital twin simulation. According to other illustrative embodiments, an automated mobile machine and computer program product for collaborative machine capability enhancement are provided.

### BRIEF DESCRIPTION OF THE DRAWINGS

FIG. 1 is a pictorial representation of a computing environment in which illustrative embodiments may be implemented;

FIG. 2 is a diagram illustrating an example of a collaborative machine capability enhancement system in accordance with an illustrative embodiment;

FIG. 3 is a diagram illustrating an example of a warehouse environment in accordance with an illustrative embodiment;

FIG. 4 is a diagram illustrating an example of a collaborative machine capability enhancement process in accordance with an illustrative embodiment;

FIG. 5 is a diagram illustrating an example of a collaborative machine pattern in accordance with an illustrative embodiment; and

FIGS. 6A-6B are a flowchart illustrating a process for collaborative machine capability enhancement in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

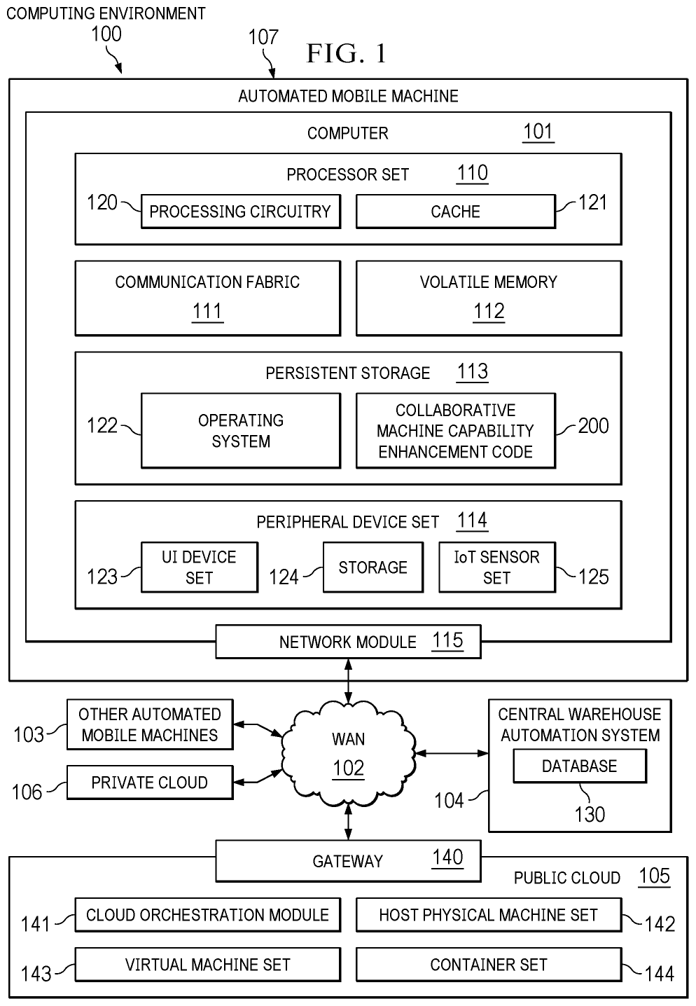

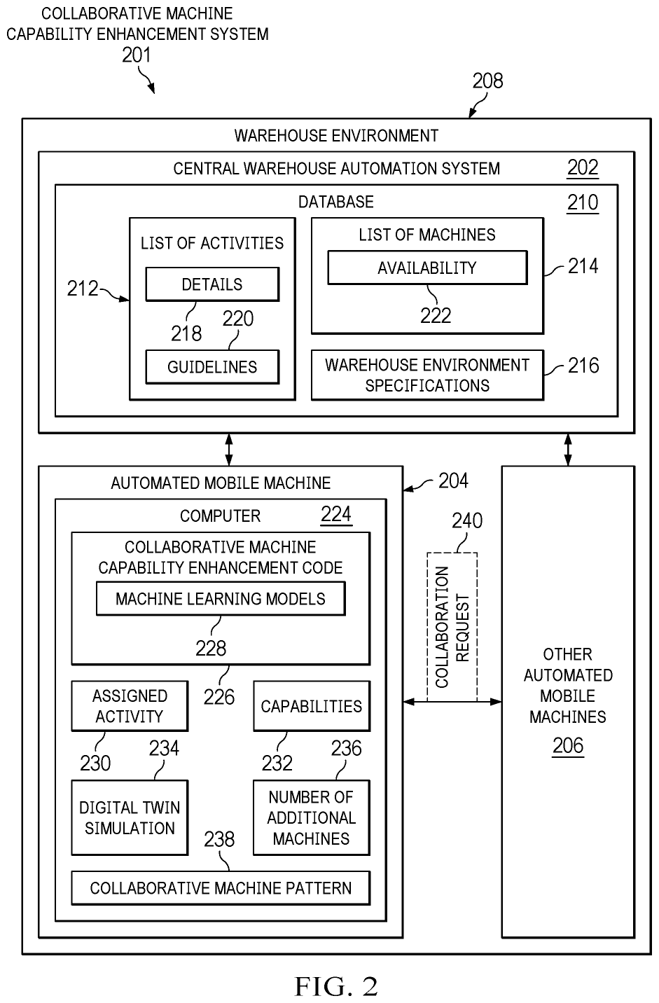

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as collaborative machine capability enhancement code 200. Collaborative machine capability enhancement code 200 increases automated mobile machine capabilities by enabling machine capability collaboration among a group of automated mobile machines to perform assigned activities in a warehouse environment.

In addition to collaborative machine capability enhancement code block 200, computing environment 100 includes, for example, computer 101, wide area network (WAN) 102, other automated mobile machines 103, central warehouse automation system 104, public cloud 105, and private cloud 106. In this embodiment, computer 101, which resides in automated mobile machine 107, includes processor set 110 (including processing circuitry 120 and cache 121), communication fabric 111, volatile memory 112, persistent storage 113 (including operating system 122 and collaborative machine capability enhancement code 200, as identified above), peripheral device set 114 (including user interface (UI) device set 123, storage 124, and Internet of Things (IoT) sensor set 125), and network module 115. Central warehouse automation system 104 includes database 130. Public cloud 105 includes gateway 140, cloud orchestration module 141, host physical machine set 142, virtual machine set 143, and container set 144.

Computer 101 may take the form of any computer or mobile data processing device now known or to be developed in the future that is capable of running a program, accessing a network, and querying a database, such as database 130. As is well understood in the art of computer technology, and depending upon the technology, performance of a computer-implemented method may be distributed among multiple computers. On the other hand, in this presentation of computing environment 100, detailed discussion is focused on a single computer, specifically computer 101, to keep the presentation as simple as possible.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.”

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in collaborative machine capability enhancement code block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The collaborative machine capability enhancement code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, touchpad, and haptic devices. Storage 124 is external storage, such as an external hard drive, or insertable storage, such as an SD card. Storage 124 may be persistent and/or volatile. IoT sensor set 125 is made up of sensors that can be used in Internet of Things applications. For example, one sensor may be an infrared sensor and another sensor may be a motion detector. Further, IoT sensor set 125 may include one or more imaging sensors, distance sensors, object sensors, speed sensors, ultrasonic sensors, location sensors, tactile sensors, laser sensors, and the like.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network, Bluetooth network, or the like. The WAN and/or LANs typically include computer hardware such as copper transmission cables, optical transmission fibers, wireless transmission, routers, firewalls, switches, gateway computers, and edge servers.

Other automated mobile machines 103 represent a plurality of automated mobile machines that perform assigned activities (e.g., transport objects) in a warehouse environment. Other automated mobile machines 103 are the same as, or similar to, automated mobile machine 107. In addition, one or more of other automated mobile machines 103 can receive messages from automated mobile machine 107. For example, in a hypothetical case where automated mobile machine 107 is configured to request collaborative assistance to perform an assigned task from other nearby automated mobile machines, this collaborative assistance request would typically be communicated from network module 115 of computer 101 to other automated mobile machines 103 via, for example, Bluetooth technology, near field communication, wireless fidelity, or the like.

Central warehouse automation system 104 is any server computer system that serves at least some data and/or functionality to automated mobile machine 107 and other automated mobile machines 103. For example, central warehouse automation system 104 assigns warehouse activities to automated mobile machine 107 and other automated mobile machines 103 and provides details and guidelines corresponding to the assigned warehouse activities for performance of those warehouse activities by automated mobile machine 107 and other automated mobile machines 103. Central warehouse automation system 104 may be controlled and used by the same entity that operates automated mobile machine 107 and other automated mobile machines 103. Central warehouse automation system 104 represents the server(s) that collect and store helpful and useful data for use by other computers, such as computer 101. For example, in a hypothetical case where computer 101 is designed and programmed to predict machine activity performance based on historical data, then this historical data may be provided to computer 101 from database 130 of central warehouse automation system 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Warehouse automation is a technical implementation to minimize human activity within warehouses and to build efficient workflows for movement of objects (e.g., products, packages, materials, stacks, bins, and the like) with minimal human intervention. Automated mobile machines are one example of how to increase efficiency, reliability, and performance in large-scale warehouse environments. A benefit of having automated mobile machines perform repetitive tasks in warehouse environments is minimization of worker fatigue and injury.

In addition, different warehouse automated mobile machines have different fixed capabilities or characteristics, such as, for example, size, power, speed, weight carrying capacity, material moving capability, and the like. As a result, these different automated mobile machines can perform certain warehouse activities based on their fixed capabilities. However, a particular warehouse activity may need multiple automated mobile machines to complete different tasks corresponding to the assigned activity. Alternatively, that particular warehouse activity may need multiple automated mobile machines to be coupled together to perform that particular activity.

Based on the type of objects stored in a warehouse, the central warehouse automation system knows which warehouse activities the automated mobile machines need to perform. However, when the number of objects to be moved is large and the time to move the objects is short, the central warehouse automation system can become overwhelmed causing decreased performance.

Further, different types of activities require that the automated mobile machines have different levels of capabilities. However, currently there are times when the central warehouse automation system is not able to assign a particular activity to one of the automated mobile machines because none of automated mobile machines in the warehouse has the needed level of capability to perform that particular activity by itself. For example, when the central warehouse automation system assigns that particular activity to one of the automated mobile machines, that particular activity overloads the machine's fixed level of capabilities preventing the machine from performing the activity. However, if multiple automated mobile machines were to be assigned to perform that particular activity together, then the activity could be performed effectively and improve the overall efficiency of the warehouse.

As an illustrative analogy, when a person is assigned an activity (e.g., task) to perform and that person realizes the activity is beyond the person's capability to do the activity alone, the person can ask one or more other people for assistance in performing the activity. Together, the group of people will have the capability to perform the activity. Similarly, illustrative embodiments enhance automated mobile machine capabilities by enabling machine capability collaboration among a group of automated mobile machines in the warehouse. For example, illustrative embodiments enable an automated mobile machine, which is assigned a warehouse activity to perform by the central warehouse automation system, to determine whether the automated mobile machine has the needed capabilities to perform the assigned activity by itself or whether the automated mobile machine needs assistance from other nearby automated mobile machines.

This self-decision-making by each respective automated mobile machine in the warehouse can improve the overall efficiency, reliability, and performance in the warehouse by, for example, satisfying customer service level agreements for delivery of objects. In this way, illustrative embodiments enable the automated mobile machines to automatically perform assigned warehouse activities in a more efficient manner.

Illustrative embodiments offload logistics intelligence from the central warehouse automation system to the automated mobile machines, themselves. As a result, each automated mobile machine is capable of analyzing its assigned activity and determining whether the automated mobile machine has the capability to perform the assigned activity or not. Further, if the automated mobile machine determines that it is incapable of performing the assigned activity based on the capabilities of the automated mobile machine and the analysis of the assigned activity, then the automated mobile machine performs a digital twin simulation to determine the appropriate machine arrangement (i.e., the collaborative pattern of machines) that can effectively perform the assigned activity together.

Thus, in response to the central warehouse automation system assigning different warehouse activities to different automated mobile machines, the automated mobile machines analyze the details of the assigned activities and determine which assigned activities can be completed by a group of automated mobile machines in a collaborative manner so that activity guidelines, such as, for example, speed of object movement and time to delivery, which are specified in service level agreements are satisfied. The automated mobile machines analyze the assigned activities and perform the digital twin simulations to identify the needed level of capabilities of the automated mobile machines to perform the assigned activities and determine how machine capability levels can be enhanced or increased with a collaborative effort by a set of additional automated mobile machines to perform certain assigned activities when a single automated mobile machine has an insufficient level of capability to perform those assigned activities.

Based on identifying an aggregate level of capabilities corresponding to a group of automated mobile machines collaboratively performing the activity assigned to a particular automated mobile machine, that particular automated mobile machine identifies whether multiple assigned activities can be merged and performed by the group of automated mobile machines utilizing the aggregate level of capabilities of the group of automated mobile machines. In other words, the group of automated mobile machines having an aggregate level of capabilities can perform a plurality of assigned activities.

The automated mobile machine assigned to perform a particular activity takes into account how completion of that particular activity is to be performed in accordance with, for example, service level agreement details (e.g., priority, due time, and the like), object details (e.g., object initial position in warehouse, object size, object weight, object fragility level, object destination range, and the like), machine capability details (e.g., current battery power level, weight carrying capacity, dimensions of the payload carrying area, and the like), warehouse details (e.g., warehouse length, width, and height, number and locations of isles, length, width, and height of each isle, and the like), average speed of the automated mobile machine based on different payload characteristics (e.g., object weight), and the like. In response to the automated mobile machine determining that the automated mobile machine is incapable of performing that particular activity by itself based on its activity analysis, the automated mobile machine performs a digital twin simulation to determine whether a number of additional automated mobile machines should be involved collaboratively with the automated mobile machine to perform that particular activity or whether that particular activity should be divided into multiple tasks to be performed by the automated mobile machine and a set of other automated mobile machines. Consequently, by performing the digital twin simulation, the automated mobile machine ensures that the assigned activity can be completed. Furthermore, by determining whether a number of additional automated mobile machines should be collaboratively combined with the automated mobile machine to perform the assigned activity or whether the assigned activity should be divided into multiple tasks to be performed by the automated mobile machine and a set of other automated mobile machines, the automated mobile machine is capable of decreasing the time to complete the assigned activity and improve machine utilization within the warehouse.

In response to determining that the assigned activity is to be performed collaboratively by the automated mobile machine and the number of additional automated mobile machines or that the assigned activity is to be divided into multiple tasks to be performed by the automated mobile machine and the set of other automated mobile machines, the automated mobile machine communicates wirelessly via, for example, Bluetooth technology, near field communication, wireless fidelity, or the like with nearby automated mobile machines to ask if the nearby automated mobile machines are available to provide assistance in performing the assigned task. Upon receiving the request for assistance from the automated mobile machine, the nearby automated mobile machines can either accept or decline the request based on availability and activity prioritization of each of the nearby automated mobile machines.

Further, when the assigned activity is to be performed collaboratively by the automated mobile machine and the number of additional automated mobile machines, the automated mobile machine determines the appropriate collaborative pattern of automated mobile machines, such as, for example, a straight line, rectangle, square, triangle, or the like. Furthermore, the automated mobile machine utilizes a set of machine learning models of an artificial intelligence component to learn from historic activity performance by the automated mobile machine, itself, and collaboratively with other automated mobile machines to improve future activity performance decisions. Moreover, when the automated mobile machine detects that a nearby automated mobile machine is going to perform the same or similar activity at the same or similar destination as the automated mobile machine, the automated mobile machine can determine that the automated mobile machine can perform the other automated mobile machine's assigned activity (i.e., that the assigned activity can be performed using fewer automated mobile machines) and release the other automated mobile machine to perform its next assigned activity.

When an automated mobile machine receives an assignment of a particular activity, the automated mobile machine uniquely identifies that particular activity based on details of the activity, such as, for example, identifier, warehouse position, weight, dimensions, fragility level, and destination range of the object to be carried or transported in the warehouse. The automated mobile machine also identifies the guidelines corresponding to that particular activity, such as, for example, service level agreement requirements, specified time to complete the assigned activity, machine speed to maintain while performing the assigned activity, and the like. The automated mobile machine analyzes the details and guidelines corresponding to that particular activity to determine whether the automated mobile machine can perform that particular activity alone based on the capabilities of the automated mobile machine.

In response to the automated mobile machine determining that the automated mobile machine is capable of performing the assigned activity itself (e.g., capable of transporting the object associated with the assigned activity itself), then the automated mobile machine performs the assigned activity in accordance with the guidelines corresponding to the assigned activity. Afterward, the automated mobile machine informs the central warehouse automation system that the assigned activity has been completed successfully and waits for the next activity assignment.

In response to the automated mobile machine determining that the automated mobile machine is incapable of performing the assigned activity itself (e.g., incapable of transporting the object associated with the assigned activity itself), then the automated mobile machine performs a digital twin simulation associated with performing the activity using the details and guidelines corresponding to the assigned activity. The automated mobile machine analyzes a result of the digital twin simulation to determine a number of additional automated mobile machines needed to collaboratively perform the assigned activity.

In response to the automated mobile machine determining the number of additional automated mobile machines needed to collaboratively perform the assigned activity, the automated mobile machine utilizes a short-range wireless communication protocol to send a message to nearby automated mobile machines within range of the wireless communication protocol requesting collaborative performance of the assigned activity with the automated mobile machine. In response to receiving an affirmative response from a sufficient number of automated mobile machines, the automated mobile machine determines a collaborative pattern of automated mobile machines comprised of the automated mobile machine and the number of additional automated mobile machines that will be collaboratively performing the assigned activity. The automated mobile machine also verifies that merged dimensions of the collaborative pattern of automated mobile machines can travel along a determined navigation path (i.e., set of isles) within the warehouse based on warehouse details. In addition, each respective automated mobile machine of the number of additional automated mobile machines sets its status as unavailable (e.g., loaded) until the assigned activity has been completed.

The automated mobile machine also verifies that the number of additional automated mobile machines, which are acting collaboratively with the automated mobile machine to perform the assigned activity, are properly engaged and utilized while performing the assigned activity until completion using coupled connections between the automated mobile machine and the number of additional automated mobile machines forming the collaborative pattern of automated mobile machines. In response to the automated mobile machine completing the assigned activity, the automated mobile machine provides feedback regarding performance of the assigned activity as additional training data for the set of machine learning models to increase predictive accuracy of activity performance by the automated mobile machine, itself, or collaboratively with other automated mobile machines (i.e., improve future decisions).

Thus, illustrative embodiments provide one or more technical solutions that overcome a technical problem with the current inability of an automated mobile machine to self-assess its ability to perform an assigned activity alone or collaboratively. As a result, these one or more technical solutions provide a technical effect and practical application in the field of automated mobile machines.

With reference now to FIG. 2, a diagram illustrating an example of a collaborative machine capability enhancement system is depicted in accordance with an illustrative embodiment. Collaborative machine capability enhancement system 201 may be implemented in a computing environment, such as computing environment 100 in FIG. 1. Collaborative machine capability enhancement system 201 is a system of hardware and software components for enhancing automated mobile machine capabilities by enabling machine capability collaboration among a group of automated mobile machines to perform assigned activities in a warehouse environment.

In this example, collaborative machine capability enhancement system 201 includes central warehouse automation system 202, automated mobile machine 204, and other automated mobile machines 206 in warehouse environment 208. Central warehouse automation system 202, automated mobile machine 204, and other automated mobile machines 206 may be, for example, central warehouse automation system 104, automated mobile machine 107, and other automated mobile machines 103 in FIG. 1. Also, even though central warehouse automation system 202 is illustrated as being located within warehouse environment 208, in an alternative illustrative embodiment, central warehouse automation system 202 can be located outside of warehouse environment 208 and connected to a plurality of warehouse environments. Warehouse environment 208 represents any type of warehouse facility that houses a plurality of different objects, such as, for example, products, packages, materials, and the like.

Central warehouse automation system 202 is in communication with automated mobile machine 204 and other automated mobile machines 206 via a set of wireless network communication protocols. For example, central warehouse automation system 202 assigns activities to automated mobile machine 204 and other automated mobile machines 206 to be performed in warehouse environment 208. In addition, central warehouse automation system 202 receives messages from automated mobile machine 204 and other automated mobile machines 206 indicating completion of assigned activities.

Central warehouse automation system 202 includes database 210, such as, for example, database 130 in FIG. 1. Database 210 stores information such as list of activities 212, list of machines 214, warehouse environment specifications 216, and the like. List of activities 212 represents a list of the different activities or tasks to be performed by automated mobile machines in warehouse environment 208. A user, such as, for example, a system administrator, creates list of activities 212. Each respective activity record in list of activities 212 includes details 218 and guidelines 220. Details 218 describe or specify attributes or characteristics of a particular activity, such as, for example, identifier of the object to be transported that corresponds to that particular activity, location of the object in warehouse environment 208, size of the object, weight of the object, fragility level of the object, destination range of the object, and the like. Guidelines 220 describe or specify how an automated mobile machine is to perform that particular activity, such as, for example, complete that particular activity in accordance with customer service level agreement requirements (i.e., within a specified time period to complete that particular activity by maintaining a specified speed while performing the activity and the like).

List of machines 214 represents a listing of all of the automated mobile machines (e.g., automated mobile machine 204 and other automated mobile machines 206) operating in warehouse environment 208. The user also creates list of machines 214. Each respective machine record in list of machines 214 includes availability 222. Availability 222 indicates whether a particular automated mobile machine is available to perform an activity (i.e., not currently engaged in performing an assigned activity itself or collaboratively with other automated mobile machines).

Warehouse environment specifications 216 represent details or aspects of warehouse environment 208, such as, for example, warehouse dimensions, floorplan, infrastructure, isle locations, isle widths, list of objects stored with identifiers, and object isle locations, and the like. The user inputs warehouse environment specifications 216 into database 210. Further, the user updates list of activities 212, list of machines 214, and warehouse environment specifications 216 as needed.

When central warehouse automation system 202 assigns a particular activity from list of activities 212 to a particular automated mobile machine (e.g., automated mobile machine 204), central warehouse automation system 202 includes details 218 and guidelines 220 corresponding to that particular activity, along with warehouse environment specifications 216, with the activity assignment. Automated mobile machine 204 includes computer 224, such as, for example, computer 101 in FIG. 1. Computer 224 includes collaborative machine capability enhancement code 226, such as, for example, collaborative machine capability enhancement code 200 in FIG. 1. Collaborative machine capability enhancement code 226 includes machine learning models 228.

Machine learning models 228 can learn without being explicitly programmed to do so. Machine learning models 228 represent a set of one or more different machine learning models. Machine learning models 228 can learn based on training data input into machine learning models 228. Machine learning models 228 can learn using various types of machine learning algorithms. The machine learning algorithms include at least one of supervised learning, semi-supervised learning, unsupervised learning, feature learning, sparse dictionary learning, association rules, or other types of learning algorithms. Examples of machine learning models 228 can include an artificial neural network, convolutional neural network, regression neural network, decision tree, support vector machine, Bayesian network, and other types of models. Machine learning models 228 can be trained using historical data corresponding to previous activity performance by automated mobile machine 204, itself, or in collaboration with other automated mobile machines.

Automated mobile machine 204 utilizes machine learning models 228 to perform an analysis of assigned activity 230 and determine whether automated mobile machine 204 can perform assigned activity 230 based on details 218 and guidelines 220 corresponding to assigned activity 230, which were received from central warehouse automation system 202 along with the activity assignment, and capabilities 232 of automated mobile machine 204. Capabilities 232 of automated mobile machine 204 represent attributes or features of automated mobile machine 204, such as, for example, dimensions, current battery power level, size of payload carrying area, average speed with different payloads, coupling capacity, maximum weight carrying capacity, material moving capability, and the like.

In response to machine learning models 228 determining that automated mobile machine 204 is capable of performing assigned activity 230 by itself, automated mobile machine 204 performs assigned activity 230 and informs central warehouse automation system 202 upon activity completion. In response to machine learning models 228 determining that automated mobile machine 204 is incapable of performing assigned activity 230 by itself, automated mobile machine 204 performs digital twin simulation 234 associated with assigned activity 230.

A digital twin is a virtual model designed to accurately reflect a physical object (i.e., automated mobile machine 204). Automated mobile machine 204 includes a plurality of different sensors related to its functionality. These sensors generate data regarding different aspects of the operating parameters and activity performance of automated mobile machine 204. Collaborative machine capability enhancement code 226 inputs the generated sensor data into a digital twin simulation component, which applies the sensor data to the virtual model of automated mobile machine 204. The digital twin simulation component generates and runs digital twin simulation 234 on the digital twin of automated mobile machine 204 to determine number of additional machines 236, which will be needed to collaboratively perform assigned activity 230 with automated mobile machine 204, and collaborative machine pattern 238.

In response to determining number of additional machines 236 and collaborative machine pattern 238, automated mobile machine 204 sends collaboration request 240 to other automated mobile machines 206 via a wireless communication protocol. In response to receiving a sufficient number of affirmative replies to collaboration request 240 from other automated mobile machines 206, automated mobile machine 204 forms collaborative machine pattern 238 with number of additional machines 236 to collaboratively perform assigned activity 230.

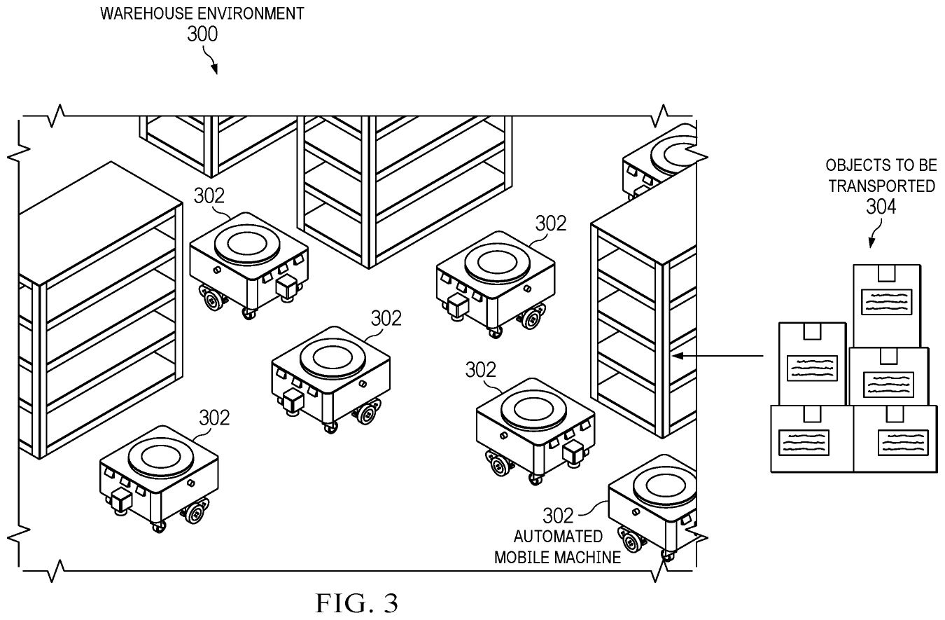

With reference now to FIG. 3, a diagram illustrating an example of a warehouse environment is depicted in accordance with an illustrative embodiment. Warehouse environment 300 may be, for example, warehouse environment 208 in FIG. 2.

In this example, warehouse environment 300 includes automated mobile machines 302 and objects to be transported 304. Automated mobile machines 302 may be, for example, automated mobile machine 107 and other automated mobile machines 103 in FIG. 1 or automated mobile machine 204 and other automated mobile machines 206 in FIG. 2. Automated mobile machines 302 are operating in warehouse environment 300 to perform assigned activities such as transporting objects (e.g., objects to be transported 304). In this example, objects to be transported 304 are packages. However, it should be noted that objects to be transported 304 are intended to be examples only and not as limitations on illustrative embodiments. In other words, objects to be transported 304 can represent any type of objects that automated mobile machines 302 can transport.

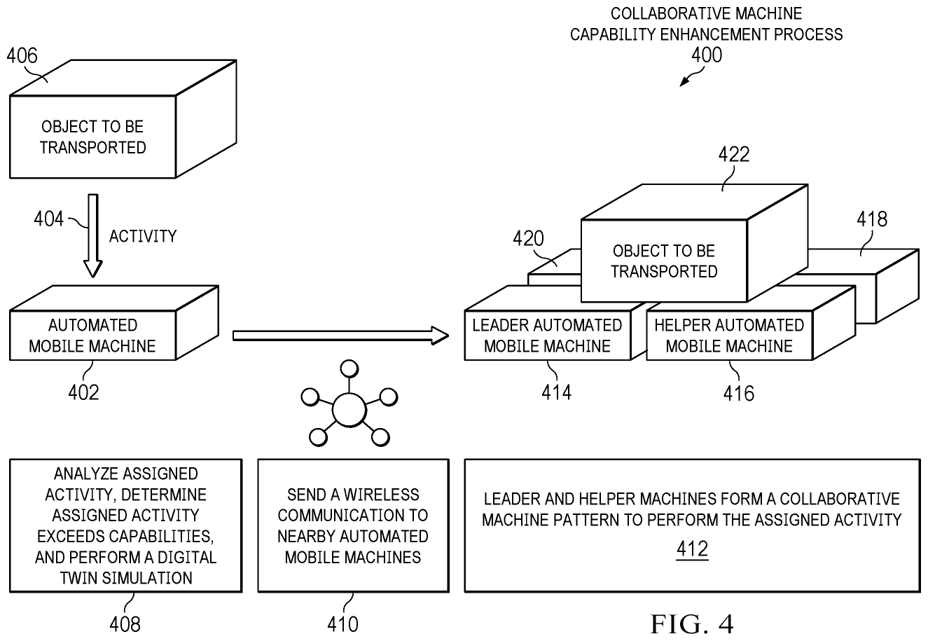

With reference now to FIG. 4, a diagram illustrating an example of a collaborative machine capability enhancement process is depicted in accordance with an illustrative embodiment. Collaborative machine capability enhancement process 400 can be implemented in a warehouse environment, such as, for example, warehouse environment 300 in FIG. 3.

In this example, collaborative machine capability enhancement process 400 includes automated mobile machine 402. Automated mobile machine 402 may be, for example, automated mobile machine 204 in FIG. 2. However, it should be noted that collaborative machine capability enhancement process 400 can include any number of automated mobile machines operating in the warehouse environment.

A central warehouse automation system, such as, for example, central warehouse automation system 202 in FIG. 2, assigns activity 404 to automated mobile machine 402. In this example, activity 404 is object to be transported 406. Object to be transported 406 may be, for example, one of objects to be transported 304 in FIG. 3.

At 408, automated mobile machine 402 analyzes activity 404, determines that activity 404 exceeds its capabilities, and performs a digital twin simulation, such as, for example, digital twin simulation 234 in FIG. 2. At 410, based on the result of the digital twin simulation, automated mobile machine 402 sends a wireless communication to nearby automated mobile machines requesting collaborative performance of activity 404.

At 412, automated mobile machine 402 becomes leader automated mobile machine 414 and forms a collaborative pattern of automated mobile machines to perform activity 404 by at least one of mechanically, electrically, or wirelessly coupling to helper automated mobile machine 416, helper automated mobile machine 418, and helper automated mobile machine 420. In this example, the collaborative pattern of automated mobile machines forms a square to carry object to be transported 422, which is the same as object to be transported 406 corresponding to activity 404.

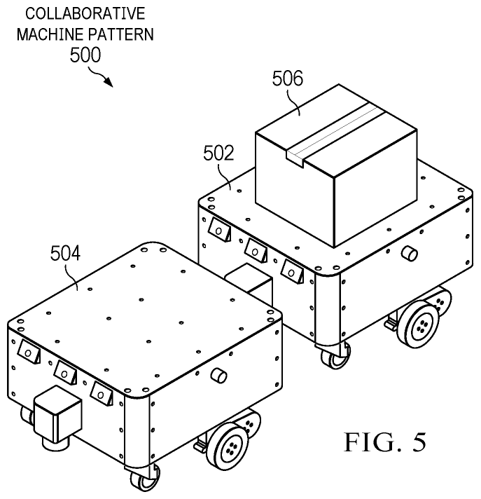

With reference now to FIG. 5, a diagram illustrating an example of a collaborative machine pattern is depicted in accordance with an illustrative embodiment. Collaborative machine pattern 500 represents a straight-line collaborative pattern of automated mobile machines, which includes automated mobile machine 502 and automated mobile machine 504, to perform an assigned activity corresponding to automated mobile machine 502.

In this example, the activity assigned to automated mobile machine 502 is to transport object 506. However, automated mobile machine 502 determined that object 506 exceeded its capabilities (e.g., object 506 weighs too much for automated mobile machine 502 to transport by itself). As a result, automated mobile machine 502 requested collaborative assistance to transport object 506. Automated mobile machine 504 responded to the request indicating that it is available and able to assist. Consequently, automated mobile machine 502 establishes a coupled connection (e.g., a mechanical, electrical, and wireless connection) to automated mobile machine 504 and transports object 506 with collaborative assistance from automated mobile machine 504.

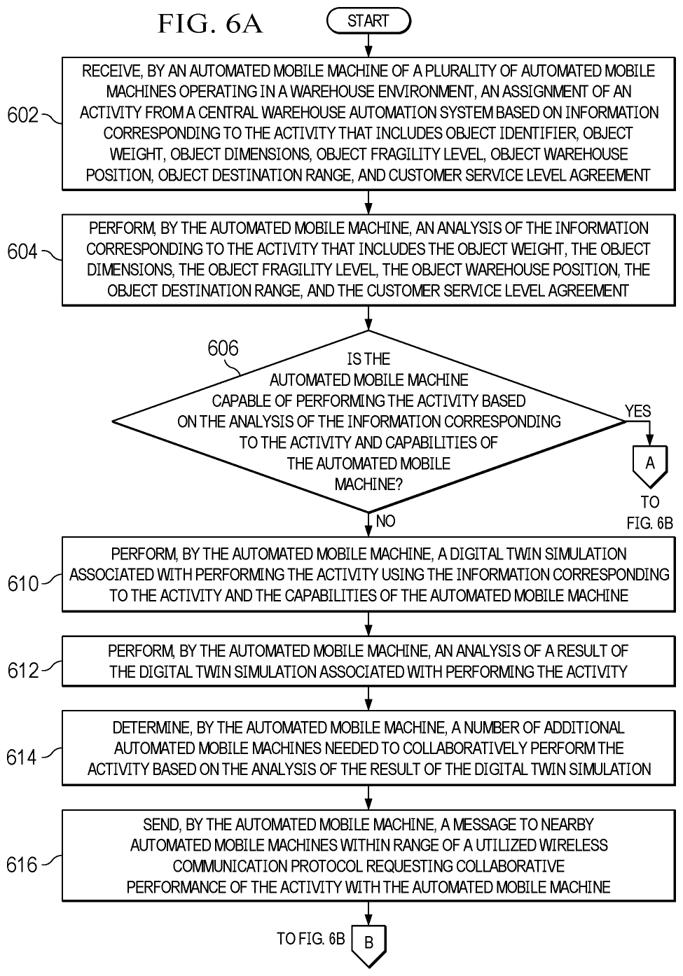

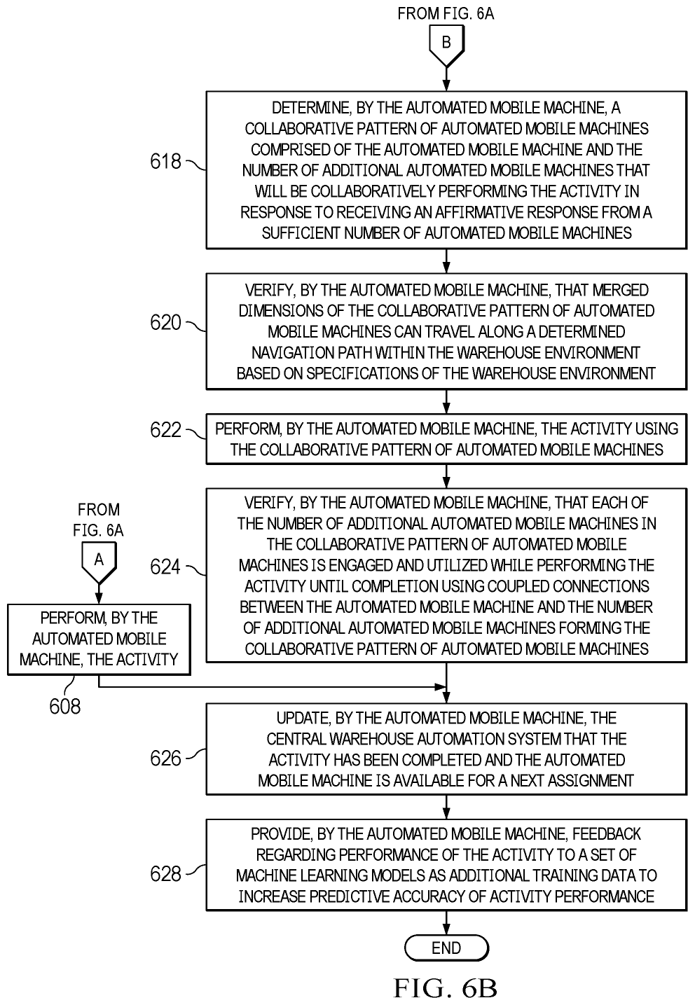

With reference now to FIGS. 6A-6B, a flowchart illustrating a process for collaborative machine capability enhancement is shown in accordance with an illustrative embodiment. The process shown in FIGS. 6A-6B may be implemented in automated mobile machine, such as, for example, automated mobile machine 107 in FIG. 1 or automated mobile machine 204 in FIG. 2. For example, the process shown in FIGS. 6A-6B may be implemented in collaborative machine capability enhancement code 200 in FIG. 1 or collaborative machine capability enhancement code 226 in FIG. 2.

The process begins when the automated mobile machine receives an assignment of an activity from a central warehouse automation system based on information corresponding to the activity that includes object identifier, object weight, object dimensions, object fragility level, object warehouse position, object destination range, and customer service level agreement (step 602). The automated mobile machine is one of a plurality of automated mobile machines operating in a warehouse environment, such as, for example, warehouse environment 208 in FIG. 2 or warehouse environment 300 in FIG. 3.

In response to receiving the assignment of the activity, the automated mobile machine performs an analysis of the information corresponding to the activity that includes the object weight, the object dimensions, the object fragility level, the object warehouse position, the object destination range, and the customer service level agreement (step 604). The automated mobile machine makes a determination as to whether the automated mobile machine is capable of performing the activity based on the analysis of the information corresponding to the activity and capabilities of the automated mobile machine (step 606).

If the automated mobile machine determines that the automated mobile machine is capable of performing the activity based on the analysis of the information corresponding to the activity and the capabilities of the automated mobile machine, yes output of step 606, then the automated mobile machine performs the activity itself (step 608). Thereafter, the process proceeds to step 626. If the automated mobile machine determines that the automated mobile machine is incapable of performing the activity based on the analysis of the information corresponding to the activity and the capabilities of the automated mobile machine, no output of step 606, then the automated mobile machine performs a digital twin simulation associated with performing the activity using the information corresponding to the activity and the capabilities of the automated mobile machine (step 610).

Afterward, the automated mobile machine performs an analysis of a result of the digital twin simulation associated with performing the activity (step 612). The automated mobile machine determines a number of additional automated mobile machines needed to collaboratively perform the activity based on the analysis of the result of the digital twin simulation (step 614).

The automated mobile machine sends a message to nearby automated mobile machines within range of a utilized wireless communication protocol requesting collaborative performance of the activity with the automated mobile machine (step 616). The automated mobile machine determines a collaborative pattern of automated mobile machines comprised of the automated mobile machine and the number of additional automated mobile machines that will be collaboratively performing the activity in response to receiving an affirmative response from a sufficient number of automated mobile machines (step 618).

In addition, the automated mobile machine verifies that merged dimensions of the collaborative pattern of automated mobile machines can travel along a determined navigation path within the warehouse environment based on specifications of the warehouse environment (step 620). Further, the automated mobile machine performs the activity using the collaborative pattern of automated mobile machines (step 622). Furthermore, the automated mobile machine verifies that each of the number of additional automated mobile machines in the collaborative pattern of automated mobile machines is engaged and utilized while performing the activity until completion using coupled connections between the automated mobile machine and the number of additional automated mobile machines forming the collaborative pattern of automated mobile machines (step 624).

Subsequently, the automated mobile machine updates the central warehouse automation system that the activity has been completed and the automated mobile machine is available for a next assignment (step 626). Moreover, the automated mobile machine provides feedback regarding performance of the activity to a set of machine learning models as additional training data to increase predictive accuracy of activity performance (step 628). Thereafter, the process terminates.

Thus, illustrative embodiments of the present invention provide a computer-implemented method, an automated mobile machine system, and computer program product for enhancing automated mobile machine capabilities by enabling machine capability collaboration among a group of automated mobile machines to perform assigned activities in a warehouse environment. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for collaborative machine capability enhancement, the computer-implemented method comprising:
determining, by an automated mobile machine, whether the automated mobile machine is capable of performing an activity based on analysis of information corresponding to the activity and capabilities of the automated mobile machine;
responsive to the automated mobile machine determining that the automated mobile machine is incapable of performing the activity based on the analysis of the information corresponding to the activity and the capabilities of the automated mobile machine, performing, by the automated mobile machine, a digital twin simulation associated with performing the activity using the information corresponding to the activity and the capabilities of the automated mobile machine;
performing, by the automated mobile machine, an analysis of a result of the digital twin simulation associated with performing the activity; and
determining, by the automated mobile machine, a number of additional automated mobile machines needed to collaboratively perform the activity based on the analysis of the result of the digital twin simulation.

2. The computer-implemented method of claim 1 further comprising:
sending, by the automated mobile machine, a message to nearby automated mobile machines within range of a utilized wireless communication protocol requesting collaborative performance of the activity with the automated mobile machine; and
determining, by the automated mobile machine, a collaborative pattern of automated mobile machines comprised of the automated mobile machine and the number of additional automated mobile machines that will be collaboratively performing the activity in response to receiving an affirmative response from a sufficient number of automated mobile machines.

3. The computer-implemented method of claim 2 further comprising:
verifying, by the automated mobile machine, that merged dimensions of the collaborative pattern of automated mobile machines can travel along a determined navigation path within a warehouse environment based on specifications of the warehouse environment.

4. The computer-implemented method of claim 2 further comprising:
performing, by the automated mobile machine, the activity using the collaborative pattern of automated mobile machines; and
verifying, by the automated mobile machine, that each of the number of additional automated mobile machines in the collaborative pattern of automated mobile machines is engaged and utilized while performing the activity until completion using coupled connections between the automated mobile machine and the number of additional automated mobile machines forming the collaborative pattern of automated mobile machines.

5. The computer-implemented method of claim 1 further comprising:
providing, by the automated mobile machine, feedback regarding performance of the activity to a set of machine learning models of the automated mobile machine as additional training data to increase predictive accuracy of activity performance.

6. The computer-implemented method of claim 1 further comprising:
receiving, by the automated mobile machine, an assignment of the activity from a central warehouse automation system, wherein the automated mobile machine is one of a plurality of automated mobile machines operating in a warehouse environment; and
performing, by the automated mobile machine, the analysis of the information corresponding to the activity that includes object weight, object dimensions, object fragility level, object warehouse position, object destination range, and customer service level agreement in response to receiving the assignment of the activity.

7. The computer-implemented method of claim 1 further comprising:
responsive to the automated mobile machine determining that the automated mobile machine is capable of performing the activity based on the analysis of the information corresponding to the activity and the capabilities of the automated mobile machine, performing, by the automated mobile machine, the activity itself.

8. An automated mobile machine for collaborative machine capability enhancement, the automated mobile machine comprising:
a communication fabric;
a storage device connected to the communication fabric, wherein the storage device stores program instructions; and
a processor connected to the communication fabric, wherein the processor executes the program instructions to:
determine whether the automated mobile machine is capable of performing an activity based on analysis of information corresponding to the activity and capabilities of the automated mobile machine;
perform a digital twin simulation associated with performing the activity using the information corresponding to the activity and the capabilities of the automated mobile machine in response to determining that the automated mobile machine is incapable of performing the activity based on the analysis of the information corresponding to the activity and the capabilities of the automated mobile machine;
perform an analysis of a result of the digital twin simulation associated with performing the activity; and
determine a number of additional automated mobile machines needed to collaboratively perform the activity based on the analysis of the result of the digital twin simulation.

9. The automated mobile machine of claim 8, wherein the processor further executes the program instructions to:
send a message to nearby automated mobile machines within range of a utilized wireless communication protocol requesting collaborative performance of the activity with the automated mobile machine; and
determine a collaborative pattern of automated mobile machines comprised of the automated mobile machine and the number of additional automated mobile machines that will be collaboratively performing the activity in response to receiving an affirmative response from a sufficient number of automated mobile machines.

10. The automated mobile machine of claim 9, wherein the processor further executes the program instructions to:
verify that merged dimensions of the collaborative pattern of automated mobile machines can travel along a determined navigation path within a warehouse environment based on specifications of the warehouse environment.

11. The automated mobile machine of claim 9, wherein the processor further executes the program instructions to:
perform the activity using the collaborative pattern of automated mobile machines; and
verify that each of the number of additional automated mobile machines in the collaborative pattern of automated mobile machines is engaged and utilized while performing the activity until completion using coupled connections between the automated mobile machine and the number of additional automated mobile machines forming the collaborative pattern of automated mobile machines.

12. The automated mobile machine of claim 8, wherein the processor further executes the program instructions to:
provide feedback regarding performance of the activity to a set of machine learning models of the automated mobile machine as additional training data to increase predictive accuracy of activity performance.

13. The automated mobile machine of claim 8, wherein the processor further executes the program instructions to:
receive an assignment of the activity from a central warehouse automation system, wherein the automated mobile machine is one of a plurality of automated mobile machines operating in a warehouse environment; and
perform the analysis of the information corresponding to the activity that includes object weight, object dimensions, object fragility level, object warehouse position, object destination range, and customer service level agreement in response to receiving the assignment of the activity.

14. A computer program product for collaborative machine capability enhancement, the computer program product comprising a computer-readable storage medium having program instructions embodied therewith, the program instructions executable by an automated mobile machine to cause the automated mobile machine to perform a method of:
determining, by the automated mobile machine, whether the automated mobile machine is capable of performing an activity based on analysis of information corresponding to the activity and capabilities of the automated mobile machine;
responsive to the automated mobile machine determining that the automated mobile machine is incapable of performing the activity based on the analysis of the information corresponding to the activity and the capabilities of the automated mobile machine, performing, by the automated mobile machine, a digital twin simulation associated with performing the activity using the information corresponding to the activity and the capabilities of the automated mobile machine;
performing, by the automated mobile machine, an analysis of a result of the digital twin simulation associated with performing the activity; and
determining, by the automated mobile machine, a number of additional automated mobile machines needed to collaboratively perform the activity based on the analysis of the result of the digital twin simulation.

15. The computer program product of claim 14 further comprising:
sending, by the automated mobile machine, a message to nearby automated mobile machines within range of a utilized wireless communication protocol requesting collaborative performance of the activity with the automated mobile machine; and
determining, by the automated mobile machine, a collaborative pattern of automated mobile machines comprised of the automated mobile machine and the number of additional automated mobile machines that will be collaboratively performing the activity in response to receiving an affirmative response from a sufficient number of automated mobile machines.

16. The computer program product of claim 15 further comprising:
verifying, by the automated mobile machine, that merged dimensions of the collaborative pattern of automated mobile machines can travel along a determined navigation path within a warehouse environment based on specifications of the warehouse environment.

17. The computer program product of claim 15 further comprising:
performing, by the automated mobile machine, the activity using the collaborative pattern of automated mobile machines; and
verifying, by the automated mobile machine, that each of the number of additional automated mobile machines in the collaborative pattern of automated mobile machines is engaged and utilized while performing the activity until completion using coupled connections between the automated mobile machine and the number of additional automated mobile machines forming the collaborative pattern of automated mobile machines.

18. The computer program product of claim 14 further comprising:
providing, by the automated mobile machine, feedback regarding performance of the activity to a set of machine learning models of the automated mobile machine as additional training data to increase predictive accuracy of activity performance.

19. The computer program product of claim 14 further comprising:
receiving, by the automated mobile machine, an assignment of the activity from a central warehouse automation system, wherein the automated mobile machine is one of a plurality of automated mobile machines operating in a warehouse environment; and
performing, by the automated mobile machine, the analysis of the information corresponding to the activity that includes object weight, object dimensions, object fragility level, object warehouse position, object destination range, and customer service level agreement in response to receiving the assignment of the activity.

20. The computer program product of claim 14 further comprising:
responsive to the automated mobile machine determining that the automated mobile machine is capable of performing the activity based on the analysis of the information corresponding to the activity and the capabilities of the automated mobile machine, performing, by the automated mobile machine, the activity itself.
